(19) United States
(12) Patent Application Publication
(10) Pub. No.: US 2023/0374856 A1
(43) Pub. Date: Nov. 23, 2023

(54) LADDER, STEP-PORTION AND SYSTEM FOR USING IN THE PROCESS OF MANUFACTURING A ROTOR BLADE

(71) Applicant: Siemens Gamesa Renewable Energy A/S, Brande (DK)

(72) Inventor: Niels Harboe, Hadsund (DK)

(21) Appl. No.: 18/142,069

(22) Filed: May 2, 2023

(30) Foreign Application Priority Data
May 19, 2022 (EP) 22174338.8

(51) Int. Cl. E06C 1/10; E06C 7/08; E06C 7/46; E06C 1/38

(52) U.S. Cl. CPC E06C 1/10; E06C 7/082; E06C 7/46; E06C 1/38; E06C 7/08

(57) ABSTRACT

A ladder for using in the process of manufacturing a rotor blade by leaning the ladder against the rotor blade being manufactured and climbing thereon is provided, including two rails and a plurality of rungs, wherein the rails include a solid structure elastically bendable by the weight of a person climbing thereon in order to align a bending radius of the rails, resulting from an elastic bending of the rails, to an outer radius of the rotor blade being manufactured. A step-portion for the inventive ladder and a system including the inventive ladder is also provided.

### CROSS-REFERENCE TO RELATED APPLICATIONS

This application claims priority to EP Application No. 22174338.8, having a filing date of May 19, 2022, the entire contents of which are hereby incorporated by reference.

### FIELD OF TECHNOLOGY

The following relates to a ladder for use in the process of manufacturing a rotor blade of a wind turbine by leaning the ladder against the rotor blade being manufactured and climbing thereon, comprising two rails and a plurality of rungs.

### BACKGROUND

During packing and/or inspection of large composite components like a wind turbine rotor blade, support structures are necessary in order to get access to upper parts of the components and the rotor blade, respectively. When manufacturing a rotor blade, the support structure will be used to reach to the upper sides and the top of the packing as part of the material lay-up process. The rotor blade and/or the semi-finished rotor blade comprises fragile fiber reinforced components, which provides a limited supporting structure. That is, in order to reach up to the desired working area, a conventional ladder cannot be used, because it could cause damage to the rotor blade by bringing too much load onto a small outer surface of the rotor blade.

Therefore, known ladders are constructed such that they follow the given geometry of the rotor blade in a certain distance from the rotor blade and incorporate a load distributing top end, taking up both the weight from the ladder as well as the weight of the operator using the ladder. If not following the geometry of the rotor blade, the operator is not within reach of the lay-up and can therefore not do what is intended. All of this ends up in a ladder being both heavy, with limited ability to be used flexible as the ladder only comes in one piece, even though the lay-up geometry differs a lot lengthwise and/or there being different types of rotor blades. Depending on the location of the ladder along the blade, the distance between the ladder and the surface of the rotor blade is not constant and accordingly, certain areas may be difficult to reach for an operator. Consequently, safety may be compromised trying to do so. Hence, operator safety is ensured by using a harness for the operator and a safety line connected to an overhead crane.

As a further problem, the weight of conventional ladders for the manufacturing process of rotor blades prevents any manual handling of the ladder. That is, a crane must be used. Consequently, the operator needs to climb down each time the ladder has to be relocated. This is both time consuming and tempting to work without a harness.

### SUMMARY

An aspect relates to a system for facilitating the manual manufacturing process of large and fragile components like rotor blades for wind turbines.

According to embodiments of the present invention, a ladder is provided for using in the process of manufacturing a rotor blade of a wind turbine by leaning the ladder against the rotor blade being manufactured and climbing thereon. The ladder comprises two rails and a plurality of rungs. The rails comprise a solid structure elastically bendable by the weight of a person climbing thereon in order to align a bending radius of the rails, resulting from an elastic bending of the rails to an outer radius of the rotor blade being manufactured.

In the conventional art, there are two types of ladders: rigid ladders that are self-supporting or that may be leaned against a vertical surface such as a wall, and rollable ladders, such as those made of rope or chains, that are meant to be hung. The inventive ladder can be considered as a rigid or basically rigid ladder, which, however, is constructed such that it will be elastically bent in a predetermined manner by the weight of a person and/or an operator climbing on the ladder. In other words, the ladder can be provided straight and/or slightly pre-curved when not subjected to a load and flexes and/or deforms elastically when subjected to a load like the weight of the person.

When leaning the inventive ladder against the rotor blade and/or the semi-finished rotor blade, there will be no gap between the ladder and the rotor blade. Thus, safety is improved as the operator will stay permanently in the harness with the safety line constantly attached. Further, an inventive ladder can be manufactured stiff and light enough to be manually handled. No crane is necessary for the placement and/or movement of the ladder at the rotor blade.

The ladder also allows the operator to stay as close to the surface of the rotor blade as possible. Therefore, ergonomics and working range can be maximized. Due to the intended bending of the ladder in order to align with the outer radius of the rotor blade or any other large building component, the load of the ladder and the operator is distributed on a much bigger surface in comparison to conventional rigid ladders, thus reducing the risk of any dislocation or wrinkles at the rotor blade occurring underneath the ladder.

Depending on the use case for the ladder, the flexibility of the rails and/or the ladder can be adapted by choosing the appropriate dimensions of the rails and/or the appropriate material. In other words, having the inventive approach, the only challenge is to choose the right dimensions and material in order to obtain the desired flexibility for adapting the shape of the ladder onto the construction part to be manufactured as well as the desired stiffness for allowing handling of the ladder by one operator only.

In an embodiment, the ladder has a height and/or length of at least 2 m, at least 3 m or at least 4 m. For example, the ladder has a length between 3 m and 6 m. By using proper material and dimensions, the total weight of the ladder can still be lower than 15 kg or even lower than 10 kg, depending on the length of the ladder. The ladder can be made of metal like aluminum, plastic and/or a composite material. Each rail may comprise a plurality of rail bars and/or rail components. The rungs or at least part of the rungs may be made of aluminum. For example, each rung may comprise a bent metal sheet, in particular aluminum sheet, with a thickness between 1 mm and 2 mm.

According to a further embodiment of the present invention, it is possible that each rail of a ladder comprises a rail bar extending in one piece over the entire length of the ladder. When providing each rail bar in one piece, the latter comprises high durability, relatively high stiffness and still the required flexibility when choosing appropriate dimensions and/or materials. Providing each rail bar in one piece means that each rail bar can be provided in one solid and/or monolithic piece.

In another embodiment of the present invention, a ladder may comprise a cushion underneath and/or at the rails and/or the rungs for contacting the rotor blade when using the ladder for the process of manufacturing the rotor blade. By the cushion, damage to the rotor blade and/or the component can be prevented during manufacturing. The cushion can be plate-shaped and/or pad-shaped. That is, the cushion may not only be provided directly at the rails and/or the rungs, but also project and/or extend over the structure of the rails and/or the rungs. The cushion may be provided in one piece or may provide a plurality of pieces, which or a part of which can be located next to each other and/or spaced from each other. A plurality of cushion parts can be provided overlapping, in particular stepwise overlapping, each other. In this way, a continuous cushion plane having a consistent thickness and/or height can be provided while still having the desired flexibility of the ladder. The cushion can be made of foam, rubber and/or any other elastically deformable material. The material of the cushion can be softer than the material of the rails and/or the rungs. When using rubber for the cushion, the cushion also prevents dislocation of the ladder due to friction towards the lay-up surface of the rotor blade.

Furthermore, it is possible that the cushion of an inventive ladder extends in a width direction between the rails from one rail to the other rail. As already mentioned, the cushion may not only be provided directly at the rails and/or the rungs, but also in between them. That way, a reliable force distribution onto the rotor blade can be achieved when using the ladder. It is that the cushion extends over the entire width of the ladder or at least almost over the entire width of the ladder, that is, from one rail to the other rail. The cushion may even extend beyond each rail, that is, in the width direction, from outside one rail over the rail to the other rail and beyond the other rail.

Moreover, it is possible that the cushion of a ladder according to embodiments of the present invention extends in a length direction between the rungs. That is, the cushion may not only extend in the width direction over the rails but also in the length direction over the rungs and/or between the rungs. This also contributes to an improved force distribution from the ladder and/or the person on the ladder onto the rotor blade during the manufacturing process when the ladder leans against the rotor blade.

A ladder according to a further embodiment of the present invention may comprise a plurality of step-portions, wherein each step-portion comprises one rung and at least part of the cushion, wherein the rung and the cushion of each step-portion build an integral and/or monolithic unit. Such step-portions may provide a modular basis for building up a ladder with a specific length and/or flexibility depending on the rotor blade and/or construction component to be manufactured. Further, in case one step and/or part of one step-portion is damaged, the damaged part can be easily replaced without the need of replacing the whole ladder. In an embodiment, the rungs and the cushion can be made of the same material. For example, both the rungs and the cushion can be made of relatively hard rubber and/or plastic with an anti-slip surface and/or coating.

An inventive ladder may further comprise a plurality of step-portions, wherein each step-portion comprises one rung and a mounting-portion for detachably mounting the step-portion to the rails. This leads, in particular, to the advantage as already mentioned above, that damaged parts can be easily replaced without the need of replacing the whole ladder in case one step and/or part of one step-portion is damaged. Further, having a specific mounting portion, building an inventive ladder by a plurality of step-portions and the rails can be easily realized. The mounting portion may comprise a resting-, clicking-, and/or snapping-structure for mounting the rails and/or the rail bars to the step-portion. That is, having the snapping-structure, for example, the rails and/or rail bars can be easily snapped into the snapping-portion when building the ladder. The mounting-portion may further comprise a guiding-structure in which the rails are located and/or locatable for guiding each step-portion along the rails. Alternatively, the step-portions and/or rungs may be firmly bonded, for example, bolted, glued and/or welded to the rails. The rails may provide a counter-mounting-structure for mounting the step-portions to a predetermined position at the rails. The counter-mounting-structure may comprise holes for screwing the step-portions to the rails, for example. Hence, an equal distance between the step-portions can be easily achieved when building the ladder. The mounting portion may further serve as connection points where upper and/or lower rail bars and/or rail bar sections can be attached. For example, the sides of the step-portions may comprise hollow tubes that rail bars can be inserted and attached, respectively.

According to a further embodiment of the present invention, a ladder may provide a plurality of spacer sleeves being located at the rails in pairs between the step-portions, for holding the step-portions in a predetermined distance from each other. In particular, when the above-mentioned plurality of cushions is not located next to each other, the spacer sleeves can be used to locate the rungs in a predetermined and equal distance to each other. Even when cushions and/or cushion elements are big enough to be located directly next to each other while providing the desired distance between the rungs, the spacer sleeves could be used in order to prevent abbreviations and thus damage to the cushion elements. The spacer sleeves are tube shaped and/or provided as a coat around the rail bars. Between each step-portion, a pair of spacer sleeves may be located at and/or around the rails.

In accordance with another embodiment of the present invention, each rung of a ladder can be roof shaped. In particular, each rung can be saddle roof shaped. That is, each rung may have a triangular shape and/or a triangular cross-section. That way, the rungs provide a stable platform for the operator even in different bending angles of the rails and the ladder, respectively. Further, the roof shaped rungs can provide a relatively large contact surface for the above-described cushion. Each roof shaped rung may comprise or be made of bent plates and/or sheets. The sheets may be made of metal like aluminum. The roof shaped rungs may also be provided as integral and/or monolithic plastic, composite and/or rubber components.

In addition, it is desired that the rails of an inventive ladder are made of a fiber reinforced composite. For example, the rails can be made of glass-fiber and/or carbon-fiber. Having the rails made of a fiber reinforced composite, they can be provided durable, rigid enough and still elastically deformable in the desired manner over the length of the ladder.

Moreover, it is possible that the rail of an inventive ladder comprises a rail bar being tube-shaped with an open-end side for detachably connecting a further rail bar in order to lengthen the ladder. With the tube-shaped and open-ended rail bars, the inventive ladder can be adapted in length as needed. Further, a system comprised of individual elements that can easily be disassembled and thus easily be stored away or transported without taking up much space can be provided. Further, a mechanism can be provided that allows a rail bar to be extended in either direction with another rail bar and/or rail bar section. Furthermore, the rail bars are hollow at either or both ends of a certain length so that an intermediate element can be inserted into the cavity and function as an extender piece between two rail bars.

In another variant, one first rail bar end is hollow and provides an inner diameter, while another rail bar provides a rail bar end having an outer diameter being complementary to the inner diameter allowing this end to be inserted into the end of the first rail bar, thus providing a telescope mechanism for elongating the rails to a certain and/or desired extend.

It is also possible that an inventive ladder comprises a base-portion at a lower end side of the rails having a coupling-structure for coupling the base-portion to a counter-coupling-structure at the ground to prevent slipping of the ladder on the ground. With the coupling structure, the ladder can be used safely with only the operator on the ladder, i.e., no further person on the ground. The coupling-structure can be shaped such that it will only provide the desired stability to the ladder in combination with the counter-coupling structure. For example, the coupling-structure may provide a protrusion to be inserted into a corresponding recess of the counter-coupling-structure in order to provide the required stability of the ladder on the ground. For example, the coupling-structure may comprise a plate- and/or sheet-shaped protrusion to be inserted into a slit- and/or groove-shaped counter-coupling-structure on the ground.

A further aspect of embodiments of the present invention relates to a step-portion, comprising one rung and a mounting-portion for detachably mounting the step-portion to the rails of a ladder as described above. Therefore, the inventive step-portion brings up the same advantages that have been discussed in detail with respect to the inventive ladder.

Another aspect of embodiments of the invention relates to a system comprising a ladder as described in detail above and the counter-coupling-structure on the ground, wherein the coupling-structure is coupled to the counter-coupling-structure. Such a system also provides the above-described advantages. When packing a topside of the rotor blade, a platform of the system may be present along a lower blade mold, for example with a platform height that allows an operator to reach into the lower blade mold. On such a platform, a steel strip of the system can be mounted flush with the platform surface as a walking area. The strip can be fitted with a groove acting as a locking device for the ladder to prevent the ladder from tilting but allowing sideways sliding along the curved surface of the rotor blade. The counter-coupling-structure can be provided on the ground, above the ground and/or underground.

In an inventive system, the counter-coupling-structure may comprise a guiding rail for guiding the ladder parallel to the rotor blade. With the guiding rail, the ladder can be shifted easily and safely along the rotor blade by one person only. The guiding rail may be provided on the ground, above the ground and/or underground. In case the guiding rail is provided underground, the guiding rail may further provide a groove shaped to guide in the ground and/or underground, extending parallel to the rotor blade and the component to be manufactured, respectively. The coupling-structure and/or the counter-coupling-structure may comprise wheels and/or a bearing carriage for an easy shifting of the latter along the rotor blade.

Further measures improving the inventive concept can be drawn from the following description of embodiments, which are schematically shown in the drawings. The features and advantages which can be drawn from the claims, from the description and from the drawings, might be considered essential alone or in combination with each other.

### BRIEF DESCRIPTION

Some of the embodiments will be described in detail, with reference to the following figures, wherein like designations denote like members, wherein:

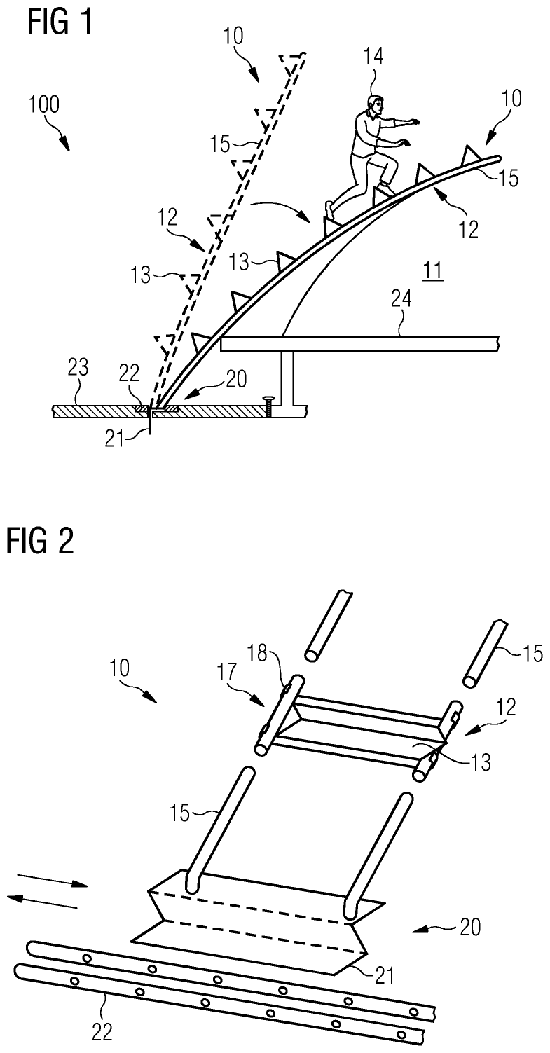

FIG. 1 shows a side view of a system according to an embodiment of the present invention;

FIG. 2 shows a perspective view of a ladder according to an embodiment of the present invention;

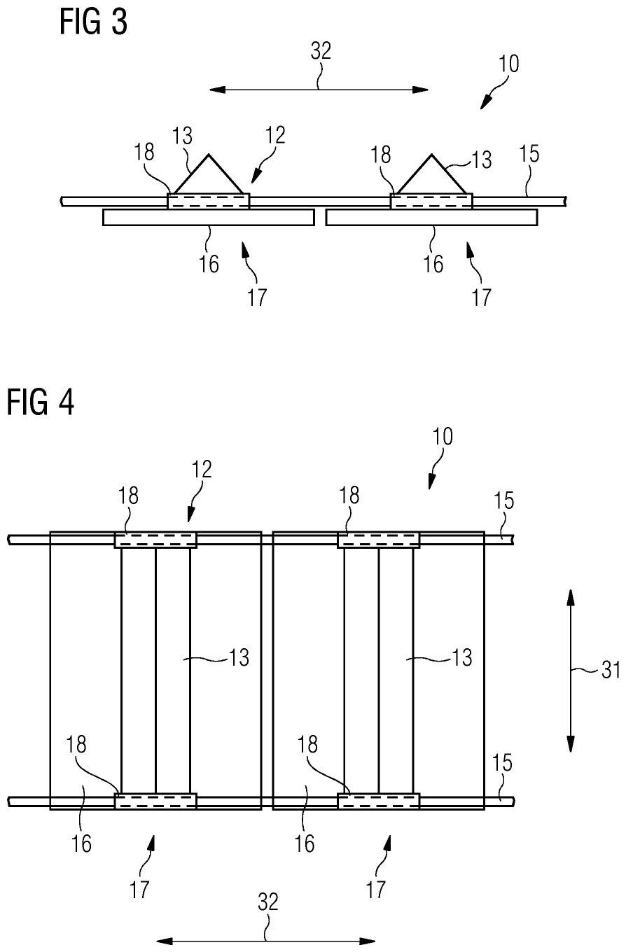

FIG. 3 shows a side view of a ladder according to a further embodiment of the present invention;

FIG. 4 shows a top view of a ladder according to the embodiment of FIG. 3;

FIG. 5 shows a side view of a ladder according to a further embodiment of the present invention; and

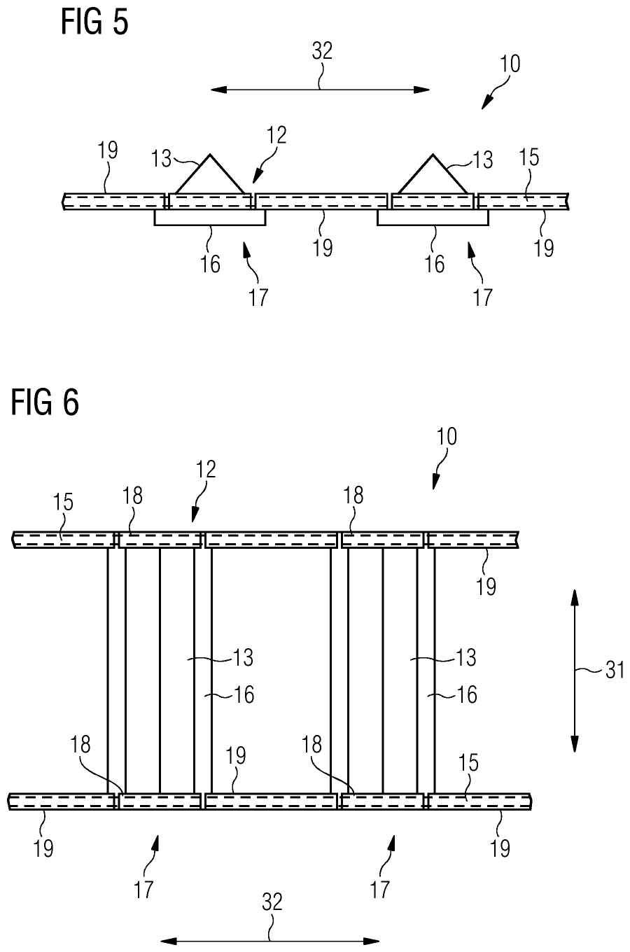

FIG. 6 shows a top view of a ladder according to the embodiment of FIG. 5.

### DETAILED DESCRIPTION

In FIG. 1, a ladder 10 is shown that is used in the process of manufacturing a rotor blade 11 of a wind turbine by leaning the ladder 10 against the rotor blade 11. As shown in FIG. 1, a person 14 and/or operator is climbing on the ladder 10 for working on the rotor blade 11. The ladder 10 comprises two rails 12 and a plurality of saddle roof shaped rungs 13. The rails 12 are made of a fiber reinforced composite and comprise a solid structure elastically bendable by the weight of the person 14 climbing thereon in order to align a bending radius of the rails 12, resulting from an elastic bending of the rails 12, to an outer radius of the rotor blade 11 being manufactured. According to the embodiment shown in FIG. 1, each rail 12 comprises a rail bar 15 extending in one piece over the entire length of the ladder 10.

The ladder 10 of FIG. 1 further comprises a base-portion 20 at a lower end side of the rails 12 having a plate-shaped coupling-structure 21 for coupling the base-portion 20 to a counter-coupling-structure 22 at the ground 23 to prevent slipping of the ladder 10 on the ground 23. In particular, FIG. 1 shows system 100, comprising the ladder 10 and the counter-coupling-structure 22 at the ground 23, wherein the coupling-structure 21 is coupled to the counter-coupling-structure 22. In accordance with the embodiment of FIG. 1, the counter-coupling-structure 22 comprises a guiding rail for guiding and shifting the ladder 10 parallel to the rotor blade 11. FIG. 1 further shows a platform 24, at which the rotor blade 11 is located and onto which the ladder 10 leans as well. The platform 24 prevents the ladder 10 from bending inwardly to the rotor blade 11 in the lower section of the ladder 10.

FIG. 2 shows parts of the ladder 10 and the counter-coupling-structure 22 in more detail. As can be further drawn from FIG. 2, the ladder 10 comprises a plurality of step-portions 17, wherein each step-portion 17 comprises one rung 13 and a mounting-portion 18 for detachably mounting the step-portion 17 to the rails 12. According to the embodiment of FIG. 2, the mounting-portion 18 comprises a snapping-portion for snapping the rail bars 15 into the snapping-portion. In the embodiment of FIG. 2, each rail 12 comprises a rail bar 15 being tube-shaped with an open-end side for detachably connecting a further rail bar 15 in order to lengthen the rails 12 and the ladder 10, respectively.

FIG. 3 shows a side view of a ladder 10 according to a further embodiment. As shown in FIG. 3, the ladder 10 comprises cushions 16 mounted underneath the rails 12 and the rungs 13 for contacting the rotor blade 11 when using the ladder 10 for the process of manufacturing the rotor blade 11. Each cushion 16 extends in a length direction 32 between the rungs 13, that is, as shown in FIG. 3, in an area between the rungs 13.

FIG. 4 shows a top view of the ladder 10 of FIG. 3. As can be seen there, each cushion 16 extends in a width direction 31 between the rails 12 from one rail 12 to the other rail 12 and slightly beyond the rails 12. The rung 13 and the cushion 16 of each step-portion 17 form an integral unit.

FIG. 5 and FIG. 6 show a further embodiment of the ladder 10. The shown ladder comprises a plurality of spacer sleeves 19 being located at the rails 12 and around the rail bars 15 in pairs between the step-portions 17 for holding the step-portions 17 in a predetermined distance from each other.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A ladder for using in the process of manufacturing a rotor blade by leaning the ladder against the rotor blade being manufactured and climbing thereon, comprising two rails and a plurality of rungs, wherein the rails comprise a solid structure elastically bendable by the weight of a person climbing thereon in order to align a bending radius of the rails, resulting from an elastic bending of the rails, to an outer radius of the rotor blade being manufactured.

2. The ladder according to claim 1, wherein each rail comprises a rail bar extending in one piece over the entire length of the ladder.

3. The ladder according to claim 1, wherein a cushion underneath the rails and/or the rungs for contacting the rotor blade when using the ladder for the process of manufacturing the rotor blade.

4. The ladder according to claim 3, wherein the cushion extends in a width direction between the rails from one rail to the other rail.

5. The ladder according to claim 3, wherein the cushion extends in a length direction between the rungs.

6. The ladder according to claim 3, wherein a plurality of step-portions, wherein each step-portion comprises one rung and at least part of the cushion, wherein the rung and the cushion of each step-portion build an integral and/or monolithic unit.

7. The ladder according to claim 1, wherein
a plurality of step-portions, each step-portion comprises one rung and a mounting-portion for detachably mounting the step-portion to the rails.

8. The ladder according to claim 7, wherein a plurality of spacer sleeves being located at the rails in pairs between the step-portions for holding the step-portions in a predetermined distance from each other.

9. The ladder according to claim 1, wherein
each rung is roof shaped.

10. The ladder according to claim 1, wherein
the rails are made of a fiber reinforced composite.

11. The ladder according to claim 1, wherein
each rail comprises a rail bar being tube-shaped with an open-end side for detachably connecting a further rail bar in order to lengthen the ladder.

12. The ladder according to claim 1, wherein a base-portion at a lower end side of the rails having a coupling-structure for coupling the base-portion to a counter-coupling-structure at the ground to prevent slipping of the ladder on the ground.

13. A step-portion, comprising one rung and a mounting-portion for detachably mounting the step-portion to the rails of a ladder according to claim 1.

14. A system, comprising a ladder according to claim 12 and the counter-coupling-structure at the ground, wherein the coupling-structure is coupled to the counter-coupling-structure.

15. The system according to claim 14, wherein the counter-coupling-structure comprises a guiding rail for guiding the ladder parallel to the rotor blade.
